(19) United States
(12) Patent Application Publication
(10) Pub. No.: US 2026/0251204 A1
(43) Pub. Date: Aug. 27, 2026

(54) LONGITUDINAL TWO-GEAR ELECTRIC DRIVE ASSEMBLY AND NEW ENERGY VEHICLE

(71) Applicant: Jing-Jin Electric Technologies Co., Ltd., Beijing (CN)

(72) Inventors: Ping YU, Beijing (CN); Jianwen LI, Beijing (CN); Changqi YANG, Beijing (CN); Hongchao ZHAO, Beijing (CN); Huaijin LIU, Beijing (CN); Qiang XU, Beijing (CN)

(73) Assignee: Jing-Jin Electric Technologies Co., Ltd., Beijing (CN)

(21) Appl. No.: 19/162,807

(22) PCT Filed: Apr. 25, 2024
(86) PCT No.: PCT/CN2024/089788

§ 371 Date: Sep. 5, 2025

(30) Foreign Application Priority Data
Jul. 18, 2023 (CN) 202321892957.2

(51) Int. Cl. F16H 3/091; B60K 1/00; B60K 17/08; B60K 17/28; F16H 63/30

(52) U.S. Cl. CPC F16H 3/0915; B60K 1/00; B60K 17/08; B60K 17/28; F16H 63/304; F16H 2063/3046; F16H 2200/0004; F16H 2200/0021; F16H 2200/0034

(57) ABSTRACT

A longitudinal two-speed electric drive assembly and a new energy vehicle are disclosed. The longitudinal two-speed electric drive assembly comprises a drive motor and a transmission mechanism. The transmission mechanism comprises an input shaft, an intermediate shaft and an output shaft. The input shaft is connected to the drive motor for transmission. The output shaft and the input shaft are coaxially arranged and connected for transmission via a first clutch. The intermediate shaft and the output shaft are arranged in parallel. The input shaft is provided thereon with a first gear. The intermediate shaft is provided thereon with a second gear and a third gear. The third gear and the intermediate shaft are connected for transmission via a second clutch. The output shaft is provided thereon with a fourth gear. The first gear and the second gear are meshed for transmission, and the third gear and the fourth gear are meshed for transmission. The first clutch and the second clutch are both electromagnetic tooth clutches. The longitudinal two-speed electric drive assembly can meet the requirements of various working conditions, and has advantages such as compact structure, high transmission efficiency, good NVH performance and low production cost.

### CROSS-REFERENCE TO RELATED APPLICATIONS

This application claims priority to the Chinese patent application No. 202321892957.2 filed with the Chinese Patent Office on Jul. 18, 2023 and entitled “Longitudinal Two-gear Electric Drive Assembly and New Energy Vehicle”, which is incorporated by reference herein in its entirety.

### TECHNICAL FIELD

The present disclosure belongs to the technical field of new energy vehicles, and specifically relates to a longitudinal two-speed electric drive assembly and a new energy vehicle.

### BACKGROUND

The drive assembly of a new energy vehicle is generally composed of a motor and a reducer. The motor first converts electrical energy into mechanical energy to provide power for the vehicle, and then reduces the motor speed by the reducer while amplifying the output torque of the motor, thereby achieving the effect of decreasing the speed and increasing the torque, so that the drive assembly can operate within a certain rotational speed range and under a certain driving torque.

At present, the drive assemblies in new energy vehicles mostly use motor direct drive or two-stage reduction drive, so that the vehicle can only achieve direct drive or power output with one reduction ratio when driving on different road sections (such as flat roads and uphill), and the high-speed condition and high-torque hill-climbing condition cannot be satisfied at the same time. If a high-power motor is used to achieve high speed and high torque output, the production cost of the drive assembly will increase, and there will also be NVH (Noise, Vibration, Harshness) problems.

### SUMMARY

In view of the above problems, the present disclosure discloses a longitudinal two-speed electric drive assembly and a new energy vehicle to overcome or at least partially solve the above problems.

In order to achieve the above object, the present disclosure adopts the following technical solutions.

An aspect of the present disclosure provides a longitudinal two-speed electric drive assembly. The longitudinal two-speed electric drive assembly comprises a drive motor and a transmission mechanism;
the transmission mechanism comprises an input shaft, an intermediate shaft and an output shaft, the input shaft is connected to the drive motor for transmission, the output shaft and the input shaft are coaxially arranged and connected for transmission via a first clutch, the intermediate shaft and the output shaft are arranged in parallel, the input shaft is provided thereon with a first gear, the intermediate shaft is provided thereon with a second gear and a third gear, the third gear and the intermediate shaft are connected for transmission via a second clutch, the output shaft is provided thereon with a fourth gear, the first gear and the second gear are meshed for transmission, and the third gear and the fourth gear are meshed for transmission;
the first clutch and the second clutch are both electromagnetic tooth clutches.

Further, the input shaft and the output shaft are connected via a bearing.

Further, the output shaft is provided thereon with a first output flange.

Further, the first clutch comprises a first fixed face gear and a first movable face gear; the first fixed face gear is fixedly connected to the input shaft, and the first movable face gear is connected to the output shaft via a spline.

Further, the second clutch comprises a second fixed face gear and a second movable face gear; the second fixed face gear is fixedly connected to the third gear, and the second movable face gear is connected to the intermediate shaft via a spline.

Further, the longitudinal two-speed electric drive assembly further comprises a power take-off mechanism connected to the intermediate shaft via a third clutch to draw power of the drive motor.

Further, the power take-off mechanism comprises a power take-off input shaft and a power take-off output shaft;
the power take-off input shaft and the intermediate shaft are arranged coaxially and connected for transmission via the third clutch, the power take-off output shaft and the power take-off input shaft are arranged in parallel, the power take-off input shaft is provided thereon with a fifth gear, the power take-off output shaft is provided thereon with a sixth gear, and the fifth gear and the sixth gear are meshed for transmission.

Further, the power take-off output shaft is provided thereon with a second output flange.

Further, the rotor shaft of the drive motor and the input shaft are an integrated structure.

Another aspect of the present disclosure provides a new energy vehicle, which uses the longitudinal two-speed drive assembly as described above.

The advantages and beneficial effects of the present disclosure are as follows.

In the longitudinal two-speed electric drive assembly of the present disclosure, by providing the intermediate shaft parallel to the input shaft and the output shaft coaxially arranged with the input shaft, the longitudinal two-speed electric drive assembly can not only realize high-speed motor direct drive, but also reduce speed and increase torque to achieve high torque output, meet the needs of various working conditions, and enable the vehicle to work efficiently under various working conditions. The longitudinal two-speed electric drive assembly has advantages such as compact structure, high transmission efficiency, good NVH performance and low production cost. In addition, the longitudinal two-speed electric drive assembly uses an electromagnetic tooth clutch, which makes the gear shifting smoother, the gear shifting response faster, and the transmission more stable.

### BRIEF DESCRIPTION OF DRAWINGS

By reading the detailed description of the preferred embodiments below, various other advantages and benefits will become clear to a person of ordinary skill in the art. The accompanying drawings are only used for the purpose of illustrating the preferred embodiments, and should not be considered as a limitation to the present disclosure. Moreover, throughout the drawings, the same reference numerals are used to denote the same components. In the drawings:

FIG. 1 is a schematic view of the structure of a longitudinal two-speed electric drive assembly in an embodiment of the present disclosure;

FIG. 2 is a torque-speed characteristic curve of the output of the longitudinal two-speed electric drive assembly in an embodiment of the present disclosure; and

FIG. 3 is a torque-vehicle speed coverage of a new energy vehicle in an embodiment of the present disclosure.

In the drawings: 1, drive motor; 2, input shaft; 3, intermediate shaft; 4, output shaft; 5, first clutch; 5-1, first fixed face gear; 5-2, first movable face gear; 6, first gear; 7, second gear; 8, third gear; 9, second clutch; 9-1, second fixed face gear; 9-2, second movable face gear; 10, fourth gear; 11, bearing; 12, first output flange; 13, power take-off input shaft; 14, power take-off output shaft; 15, fifth gear; 16, sixth gear; 17, second output flange; 18, third clutch.

### DETAILED DESCRIPTION

In order to make the object, technical solutions, and advantages of the present disclosure clearer, the present disclosure will be described clearly and completely in conjunction with the specific embodiments and corresponding drawings. Obviously, the embodiments described are only part of rather than all of the embodiments of the present disclosure. Based on the embodiments in the present disclosure, all other embodiments obtained by those of ordinary skill in the art without paying creative work shall fall within the protection scope of the present disclosure.

The technical solutions provided by various embodiments of the present disclosure will be described in detail with reference to the accompanying drawings.

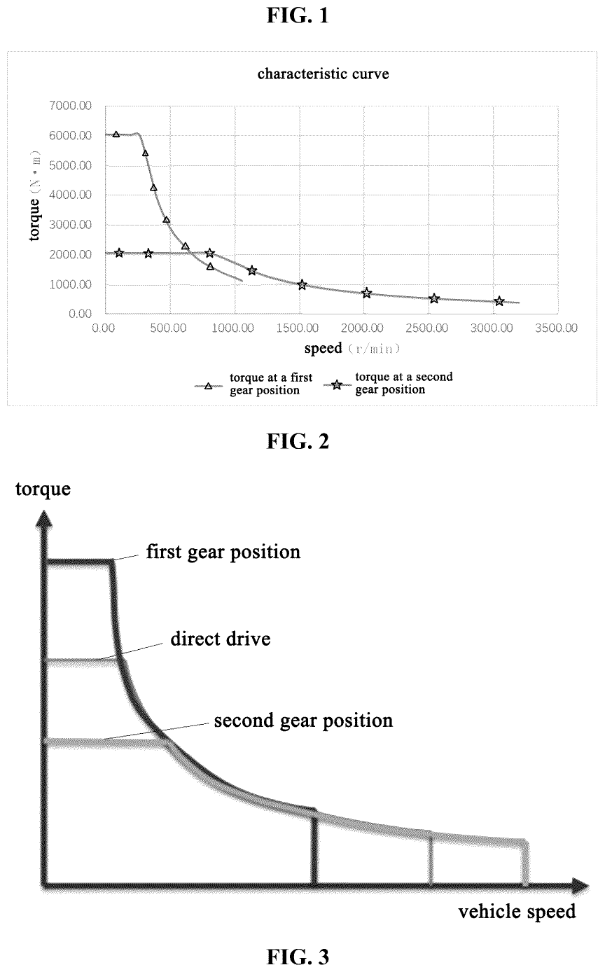

A longitudinal two-speed electric drive assembly is disclosed in an embodiment of the present disclosure. As shown in FIG. 1, the longitudinal two-speed electric drive assembly comprises a drive motor 1 and a transmission mechanism.

Specifically, the transmission mechanism comprises an input shaft 2, an intermediate shaft 3 and an output shaft 4. The input shaft 2 is connected to the drive motor 1 for transmission. The output shaft 4 and the input shaft 2 are coaxially arranged, and connected for transmission via a first clutch 5. The intermediate shaft 3 and the output shaft 4 are arranged in parallel. The input shaft 2 is provided thereon with a first gear 6. The intermediate shaft 3 is provided thereon with a second gear 7 and a third gear 8. The third gear 8 and the intermediate shaft 3 are connected for transmission via a second clutch 9. The output shaft 4 is provided thereon with a fourth gear 10. The first gear 6 and the second gear 7 are meshed for transmission. The third gear 8 and the fourth gear 10 are meshed for transmission.

The first clutch 5 and the second clutch 9 are both electromagnetic tooth clutches. The electromagnetic tooth clutch can transmit a torque greater than 2000 N·m in a limited space, and can withstand the impact of speed difference due to inaccurate synchronization, reduce the speed synchronization requirements during the speed change process, and save the speed regulation time under the conditions of large speed ratio difference and large speed regulation range.

The specific working process of the longitudinal two-speed electric drive assembly in this embodiment is as follows.

The implementation process at the first gear position (low-speed gear) is as follows. The first clutch 5 is controlled to disengage, and the second clutch 9 is controlled to engage. At this point, the power generated by the drive motor 1 is transmitted to the first gear 6 via the input shaft 2. The first gear 6 and the second gear 7 are meshed to transmit the power to the intermediate shaft 3, thereby realizing a first-stage speed reduction. Then, the intermediate shaft 3 drives the third gear 8 to rotate via the second clutch 9, and the third gear 8 and the fourth gear 10 are meshed to transmit the power to the output shaft 4, thereby realizing a second-stage speed reduction. Thus, the longitudinal two-speed electric drive assembly can output high-torque and low-speed driving force for the starting or hill-climbing conditions of the vehicle.

The implementation process at the second gear position (high-speed gear) is as follows. The first clutch 5 is controlled to engage, and the second clutch 9 is controlled to disengage. At this point, the power generated by the drive motor 1 is transmitted to the input shaft 2, and the input shaft 2 drives the output shaft 4 to rotate via the first clutch 5, thereby realizing direct drive of the drive motor 1, providing a high-speed and low-torque driving force for the vehicle, and meeting the normal driving needs of the vehicle.

As can be seen from FIG. 2, the longitudinal two-speed electric drive assembly of this embodiment can output power with large torque and low speed at a first gear position, and achieve power output with small torque and high speed at a second gear position.

In sum, in the longitudinal two-speed electric drive assembly of this embodiment, by providing the intermediate shaft parallel to the input shaft and the output shaft coaxially arranged with the input shaft, the longitudinal two-speed electric drive assembly can not only realize high-speed motor direct drive, but also reduce speed and increase torque to achieve high torque output, meet the needs of various working conditions, and enable the vehicle to work efficiently under various working conditions. The longitudinal two-speed electric drive assembly has advantages such as compact structure, high transmission efficiency, good NVH performance and low production cost. In addition, the longitudinal two-speed electric drive assembly uses an electromagnetic tooth clutch, which makes the gear shifting smoother, the gear shifting response faster, and the transmission more stable.

In this embodiment, as shown in FIG. 1, the input shaft 2 and the output shaft 4 are connected by a bearing 11, so that the input shaft 2 and the output shaft 4 are better coaxial and the rotation is more stable.

Moreover, the output shaft 4 is provided thereon with a first output flange 12. In this way, the longitudinal two-speed electric drive assembly can transmit power to the axle drive shaft via the first output flange 12, thereby providing a driving force for the vehicle.

In addition, the first clutch 5 comprises a first fixed face gear 5-1 and a first movable face gear 5-2.

The first fixed face gear 5-1 is fixedly connected to the input shaft 2, and the first movable face gear 5-2 is connected to the output shaft 4 via a spline. In this way, when the first fixed face gear 5-1 and the first movable face gear 5-2 are engaged, the input shaft 2 can drive the output shaft 4 to rotate and transmit power to the output shaft 4.

Further, the second clutch 9 comprises a second fixed face gear 9-1 and a second movable face gear 9-2.

The second fixed face gear 9-1 is fixedly connected to the third gear 8, and the second movable face gear 9-2 is connected to the intermediate shaft 3 via a spline. In this way, when the second fixed face gear 9-1 and the second movable face gear 9-2 are meshed, the intermediate shaft 3 can drive the third gear 8 to rotate and transmit power to the third gear 8.

In this embodiment, as shown in FIG. 1, the longitudinal two-speed electric drive assembly also comprises a power take-off mechanism.

The power take-off mechanism is connected to the intermediate shaft 3 for transmission via the third clutch 18, and is used to draw the power of the drive motor and transmit it to other systems of the vehicle that need power, such as the mixing system of the mixer truck, the cleaning system of the automatic sweeper, etc.

It should be noted that, since the first gear 6 is fixedly connected to the input shaft 2, the third gear 8 is fixedly connected to the intermediate shaft 3, and the first gear 6 and the third gear 8 are connected for transmission, when the drive motor 1 rotates, no matter whether the longitudinal two-speed electric drive assembly is at the first gear position or the second gear position, or at the neutral gear position, the drive motor 1 will drive the intermediate shaft 3 to rotate. In this way, the intermediate shaft 3 can draw the power via the power take-off mechanism, and the output of the power take-off mechanism will not affect the normal driving force output of the longitudinal two-speed electric drive assembly.

Specifically, the power take-off mechanism comprises a power take-off input shaft 13 and a power take-off output shaft 14, and the power is output via the power take-off output shaft 14.

The power take-off input shaft 13 and the intermediate shaft 3 are coaxially arranged, and are connected for transmission via the third clutch 18. The third clutch 18 can be used to control on/off of the power transmission between the power take-off mechanism and the intermediate shaft 3. That is, when the power take-off mechanism does not need power, the power transmission can be cut off by controlling the third clutch 18 to disengage. The power take-off output shaft 14 and the power take-off input shaft 13 are arranged in parallel, and the power take-off input shaft 13 is provided thereon with a fifth gear 15, the power take-off output shaft 14 is provided thereon with a sixth gear 16, and the fifth gear 15 and the sixth gear 16 are meshed for transmission. In this way, when the third clutch 18 is engaged, the intermediate shaft 3 will drive the power take-off input shaft 13 to rotate via the third clutch 18, the power take-off input shaft 13 will drive the fifth gear 15 to rotate, and the fifth gear 15 and the sixth gear 16 will be meshed to deliver the power to the power take-off output shaft 14, thereby realizing the power output of the power take-off mechanism.

Further, the power take-off output shaft 14 is provided thereon with a second output flange 17, and the power take-off mechanism can transmit power to other systems of the vehicle that need power via the second output flange 17.

In addition, the rotor shaft of the drive motor and the input shaft of the transmission mechanism are an integrated structure, so that when power is transmitted, the impact of the rotor shaft of the drive motor on the transmission mechanism can be reduced, and the transmission loss can be reduced. In other embodiments of the present disclosure, alternatively, the rotor shaft of the drive motor may be connected to the input shaft of the transmission mechanism via a coupling.

In another embodiment of the present disclosure, a new energy vehicle is disclosed, which uses the longitudinal two-speed electric drive assembly in the above embodiment. As shown in FIG. 3, the torque-vehicle speed coverage of the new energy vehicle at the first and second gear positions is wider than the coverage of the traditional direct drive, and can meet the needs of different working conditions.

The above merely describes particular embodiments of the present disclosure. By the teaching of the present disclosure, a person skilled in the art can make other modifications or variations based on the above embodiments. A person skilled in the art should appreciate that, the detailed description above is only for the purpose of explaining the present disclosure, and the protection scope of the present disclosure should be subject to the protection scope of the claims.

1. A longitudinal two-speed electric drive assembly, comprising:
a drive motor and a transmission mechanism;
wherein the transmission mechanism comprises an input shaft, an intermediate shaft and an output shaft, the input shaft is connected to the drive motor for transmission, the output shaft and the input shaft are coaxially arranged and connected for transmission via a first clutch, the intermediate shaft and the output shaft are arranged in parallel, the input shaft is provided thereon with a first gear, the intermediate shaft is provided thereon with a second gear and a third gear, the third gear and the intermediate shaft are connected for transmission via a second clutch, the output shaft is provided thereon with a fourth gear, the first gear and the second gear are meshed for transmission, and the third gear and the fourth gear are meshed for transmission;
wherein the first clutch and the second clutch are both electromagnetic tooth clutches.

2. The longitudinal two-speed electric drive assembly according to claim 1, wherein the input shaft and the output shaft are connected via a bearing.

3. The longitudinal two-speed electric drive assembly according to claim 1, wherein the output shaft is provided thereon with a first output flange.

4. The longitudinal two-speed electric drive assembly according to claim 1, wherein the first clutch comprises a first fixed face gear and a first movable face gear;
the first fixed face gear is fixedly connected to the input shaft, and the first movable face gear is connected to the output shaft via a spline.

5. The longitudinal two-speed electric drive assembly according to claim 1, wherein the second clutch comprises a second fixed face gear and a second movable face gear;
the second fixed face gear is fixedly connected to the third gear, and the second movable face gear is connected to the intermediate shaft via a spline.

6. The longitudinal two-speed electric drive assembly according to claim 1, further comprising:
a power take-off mechanism connected to the intermediate shaft for transmission via a third clutch to draw power of the drive motor.

7. The longitudinal two-speed electric drive assembly according to claim 6, wherein the power take-off mechanism comprises a power take-off input shaft and a power take-off output shaft;
the power take-off input shaft and the intermediate shaft are arranged coaxially and connected for transmission via the third clutch, the power take-off output shaft and the power take-off input shaft are arranged in parallel, the power take-off input shaft is provided thereon with a fifth gear, the power take-off output shaft is provided thereon with a sixth gear, and the fifth gear and the sixth gear are meshed for transmission.

8. The longitudinal two-speed electric drive assembly according to claim 7, wherein the power take-off output shaft is provided thereon with a second output flange.

9. The longitudinal two-speed electric drive assembly according to claim 1, wherein the rotor shaft of the drive motor and the input shaft are an integrated structure.

10. A new energy vehicle using the longitudinal two-speed electric drive assembly according to claim 1.

11. The longitudinal two-speed electric drive assembly according to claim 2, wherein the rotor shaft of the drive motor and the input shaft are an integrated structure.

12. The longitudinal two-speed electric drive assembly according to claim 3, wherein the rotor shaft of the drive motor and the input shaft are an integrated structure.

13. The longitudinal two-speed electric drive assembly according to claim 4, wherein the rotor shaft of the drive motor and the input shaft are an integrated structure.

14. The longitudinal two-speed electric drive assembly according to claim 5, wherein the rotor shaft of the drive motor and the input shaft are an integrated structure.

15. The longitudinal two-speed electric drive assembly according to claim 6, wherein the rotor shaft of the drive motor and the input shaft are an integrated structure.

16. A new energy vehicle using the longitudinal two-speed electric drive assembly according to claim 2.

17. A new energy vehicle using the longitudinal two-speed electric drive assembly according to claim 3.

18. A new energy vehicle using the longitudinal two-speed electric drive assembly according to claim 4.

19. A new energy vehicle using the longitudinal two-speed electric drive assembly according to claim 5.

20. A new energy vehicle using the longitudinal two-speed electric drive assembly according to claim 6.
